(19) United States
(12) Patent Application Publication
(10) Pub. No.: US 2012/0176886 A1
(43) Pub. Date: Jul. 12, 2012

(54) METHOD AND SYSTEM FOR OPTICAL ORTHOGONAL FREQUENCY DIVISION MULTIPLEXING WITH HADAMARD TRANSFORM COMBINED WITH COMPANDING TRANSFORM

(75) Inventor: Jianjun Yu, Princeton, NJ (US)

(73) Assignees: ZTE Corporation, Shenzhen (CN); ZTE (USA) INC., Richardson, TX (US)

(21) Appl. No.: 13/339,476

(22) Filed: Dec. 29, 2011

Related U.S. Application Data
(60) Provisional application No. 61/431,255, filed on Jan. 10, 2011.
(60) Provisional application No. 61/513,876, filed on Aug. 1, 2011.

(51) Int. Cl. H04J 11/00

(52) U.S. Cl. 370/210

(57) ABSTRACT

A combined Hadamard and companding transform technique is incorporated into orthogonal frequency division multiplexed signals to reduce the peak-to-average ratio of signals. A Hadamard transform is applied to the signals to generate a first transformed signal of subsymbols. An Inverse Fast Fourier Transform is performed on the subsymbols to generate a second transformed signal of the subsymbols. The second transformed signal is then companded, making them ready for transmission as optical signals.

### FIELD OF THE INVENTION

The field of the present invention relates to optical communication architecture, particularly to optical communication processes and systems which employ orthogonal frequency division multiplexing.

### BACKGROUND

In recent years, orthogonal frequency division multiplexing (“OFDM”) has been considered one of the most promising transmission schemes for future networks. As described by S. L. Jansen et al.: “121.9-Gb/s PDM-OFDM transmission with 2-b/s/Hz spectral efficiency over 1000 km of SSMF,” in J. Lightwave Technology, vol. 27, pp. 177-188, January 2008; by Y. Ma et al.: “1-Tb/s per channel coherent optical OFDM transmission with subwavelength bandwidth access”, in Proc. OFC 2009, San Diego, USA, March 2009; and by R. Dischler, F. Buchali: “Transmission of 1.2 Tb/s continuous waveband PDM-OFDM-FDM signal with spectral efficiency of 3.3 bits/s/Hz over 400 km of SSMF”, in Proc. OFC 2009, San Diego, USA, March 2009; OFDM offers virtually unlimited electrical compensation of chromatic dispersion and polarization mode dispersion (“PMD”) as well as record spectral efficiency. However, as described in J. Armstrong: “OFDM for Optical Communications”, J. Lightwave Technology, vol. 27, pp. 189-204, February 2008, and J. Armstrong, “Peak-to-Average Power Reduction for OFDM by Repeated Clipping and Frequency Domain Filtering”, in Electronic Letters, vol. 38, no. 5, pp. 246-247, Feb. 2002; one major drawback of OFDM optical signals is their high peak-to-average power ratio (“PAPR”), which gives rise to distortions caused by nonlinear devices. Such nonlinear devices include Analog/Digital (“A/D”) converters, external modulators and power amplifiers. Furthermore, because the nonlinear effects such as self-phase modulation, cross-phase modulation, and four-wave mixing in the transmission fiber are proportional to an instantaneous signal power, a large PAPR will cause strong nonlinear impairments to degrade the transmission performance, such as is analyzed in D. Wulich, “Definition of efficient PAPR in OFDM,” in IEEE Communication Letters, vol. 9, no. 9, pp. 832-834, Sep. 2005.

In order to overcome these negative effects, many methods have been introduced in recent years. One such method, trellis shaping, is described by H. Ochiai, “A novel trellis-shaping design with both peak and average power reduction for OFDM systems,” in IEEE Transactions on Communications, vol. 52, no. 11, pp. 1916-1926, November 2004. Additionally, a method of applying a Hadamard transform to reduce the PAPR in optical OFDM systems has been proposed by M Park, H. Jun, J. Cho, N. Cho, D. Hong, C. Kang, “PAPR reduction in OFDM transmission using Hadamard transform,” in IEEE International Conference on Communications, vol. 1, pp. 430-433, 2000.

However, a hybrid technique of a Hadamard transform and a companding transform may offer better performance in terms of PAPR reduction and BER for OFDM systems.

### SUMMARY OF THE INVENTION

The present invention is directed toward methods and systems for lowering a peak-to-average power ratio (“PAPR”) of orthogonal frequency division multiplexing (OFDM) systems.

In these methods and systems, orthogonal frequency division multiplexing is employed by applying a combination of Hadamard and companding transforms to decrease the PAPR of resulting optical signals. Initially, a Hadamard transform is applied to a signal to form a first transformed signal of subsymbols. Subsequently, an Inverse Fast Fourier Transform (“IFFT”) is performed on the subsymbols to form a second transformed signal of the subsymbols. The second transformed signal is then companded, resulting in a companded signal of the subsymbols, which is ready for transmission as an optical signal.

Additional aspects and advantages of the improvements will appear from the description of the preferred embodiment.

### BRIEF DESCRIPTION OF THE DRAWINGS

Embodiments of the present invention are illustrated by way of the accompanying drawings, in which:

FIG. 1 is a block diagram of an intensity-modulation and direction-detection (“IM-DD”) OFDM system using a Hadamard transform combined with a companding transform.

FIG. 2 illustrates sample complementary cumulative distribution function (“CCDF”) curves of the PAPR for an OFDM signal.

FIG. 3 illustrates an experimental setup and optical spectra of an IM-DD OFDM system.

FIG. 4 illustrates sample Bit Error Rate (“BER”) curves for an original OFDM signal and companding signals with different μ values, and at 8 dBm launch power.

FIG. 5 illustrates sample BER curves for an original OFDM signal and OFDM signals using a Hadamard transform combined with a companding transform with different μ values, and at 8 dBm launch power.

FIG. 6 illustrates sample BER curves for an original OFDM signal, an OFDM signal using a Hadamard transform, an ODFM signal using a companding transform with μ=2, and an OFDM signal using a combined Hadamard transform and companding transform with μ=2, and at 2 dBm launch power.

FIG. 7 illustrates sample BER curves for an OFDM original signal and an OFDM signal using a companding transform with different μ values, and at 3 dBm launched power.

FIG. 8 illustrates sample BER curves for an OFDM original signal and OFDM signals using a Hadamard transform combined with companding transform with different μ values, and at 3 dBm launch power.

FIG. 9 illustrates sample BER curves for an OFDM original signal, an OFDM signal using a Hadamard transform, an ODFM signal using a companding transform with μ=2, and an OFDM signal using a combined Hadamard transform and companding transform with μ=2, and at 3 dBm launch power.

FIG. 10 illustrates sample BER curves for an OFDM original signal and an OFDM signal using a companding transform with different μ values, and at 3 dBm launch power.

FIG. 11 illustrates sample BER curves for an OFDM original signal and OFDM signals using a Hadamard transform combined with companding transform with values of μ, and at 8 dBm launch power.

FIG. 12 illustrates sample BER curves for an OFDM original signal, an OFDM signal using a Hadamard transform, an ODFM signal using a companding transform with μ=2, and an OFDM signal using a combined Hadamard transform and companding transform with μ=2, and at 8 dBm launch power.

FIG. 13 illustrates sample BER curves for an OFDM original signal and OFDM signals using a Hadamard transform combined with a companding transform with μ=1, and at different launch powers.

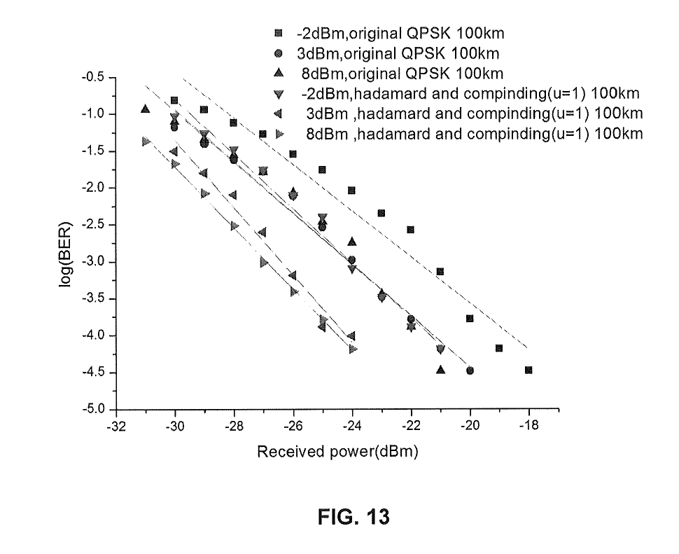

FIG. 14 illustrates sample BER curves for an OFDM original signal and OFDM signals using a Hadamard transform combined with companding transform with μ=2, and at different launch powers.

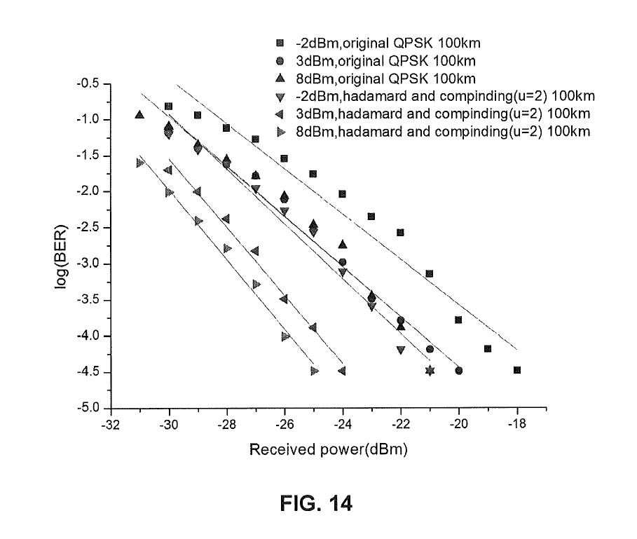

FIG. 15 illustrates sample BER curves for an OFDM original signal and OFDM signals using a Hadamard transform combined with a companding transform with μ=3, and at different launch powers.

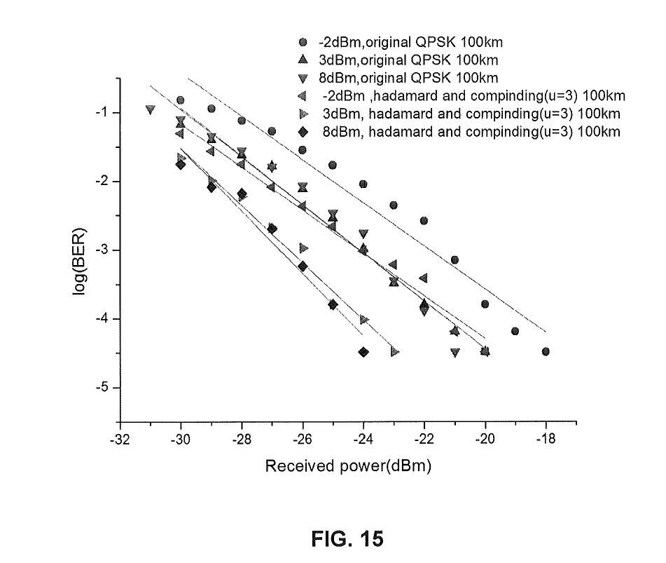

### DETAILED DESCRIPTION OF THE PREFERRED EMBODIMENTS

Direct-detection optical OFDM methods and systems disclosed herein employ hybrid techniques of Hadamard transforms combined with μ-law companding transforms. As described in M Park, H. Jun, J. Cho, N. Cho, D. Hong, C. Kang, “PAPR reduction in OFDM transmission using Hadamard transform,” in IEEE International Conference on Communications, vol. 1, pp. 430-433, 2000, a Hadamard transform may reduce a PAPR of an OFDM signal while affecting the error probability or average power level of a system. The μ-law companding transform mainly focuses on enlarging small signals. Theoretical and experimental results herein show that a Hadamard transform combined with a companding transform is able to offer better performance in terms of PAPR reduction and BER reduction for OFDM systems.

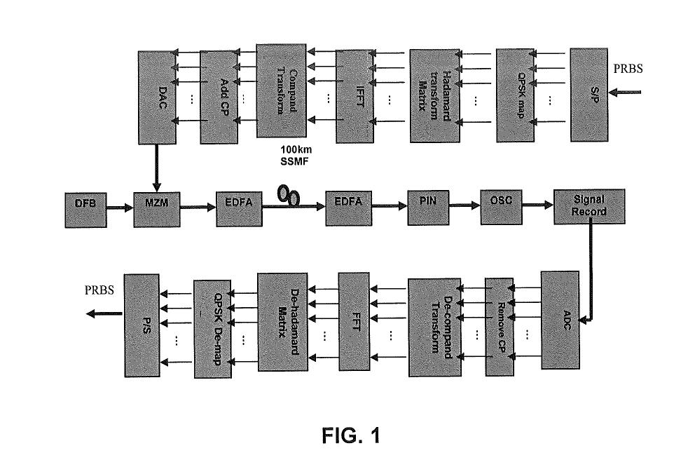

FIG. 1 shows an intensity-modulation and direct-detection (“IM-DD”) OFDM transmission system using a Hadamard transform combined with a companding transform. Base-band modulated symbols (or pseudo-random binary sequences “PRBS”) are first passed through a serial to parallel converter (“S/P”). After a Quadrature Phase Shift Keying (“QPSK”) mapping, the Hadamard transform is applied to reduce the correlation of the input OFDM sequence. The Hadamard transform is also used to reduce the PAPR of the OFDM signal.

### Hadamard Transform

A kernel of a Hadamard transform can be generated by a recursive procedure. A Hadamard matrix of order N is a matrix H_{N} with elements 1 or −1 such that H_{N}·H_{N}^{T}=NI_{N}. The Hadamard matrix of 2 orders is stated by:

$${H}_{2} = [ \begin{matrix}1 & 1 \\ 1 & - 1\end{matrix} ] .$$

The Hadamard matrix of order N may be constructed by:

$${H}_{N} = [ \begin{matrix}{H}_{N / 2} & {H}_{N / 2} \\ {H}_{N / 2} & - {H}_{N / 2}\end{matrix} ] ,$$

where −H_{N/2} is the complementary of H_{N/2}, H_{N}^{T} is the transport matrix, and I_{N} is an identity matrix of n order. After the sequence x={x₀,x₁, . . . x_{N-1}}^{T} is transformed by the Hadamard matrix of order N, the new sequence \hat{X}_{N} is \hat{X}_{N}=IFFT{H_{N}X_{N}}. This is because the Hadamard transform is an orthogonal linear transform and can be implemented by a butterfly structure as in a Fast Fourier Transforms (“FFT”). Therefore, applying the Hadamard transform does not require the extensive increase of system complexity.

The PAPR of an OFDM system applying a Hadamard transform can be defined as:

$$PAPR = \frac{max {\vert {\hat{X}}_{N} \vert}^{2}}{E \{ {\vert {\hat{X}}_{N} \vert}^{2} \}} ,$$

where E{•} denotes the expected value; and E{|\hat{X}_{N}|²} is equal to a variance σ_{\hat{x}}² since the symbols are zero-mean. Statistics of the PAPR of an OFDM signal can be given in terms of the OFDM signal's clipping probability or its complementary cumulative distribution function (“CCDF”). The CCDF for an OFDM signal is defined as:

P(PAPR>PAPR0)=1−(1−e^{-PAPR0})^{N}, PAPR₀>0

where PAPR0 is a clipping level or symbol clip probability. This equation can be interpreted as the probability that the PAPR of a symbol block exceeds some clip level PAPR0.

Next, an Inverse Fast Fourier Transform (“IFFT”) is applied to the randomly generated N subsymbols output from the Hadamard transform. After applying the IFFT, an OFDM baseband signal can be expressed as:

$${x}_{n} = \frac{1}{\sqrt{N}} {\sum }_{k = 0}^{N - 1} {X}_{k} \cdot {e}^{j 2 π \frac{n}{N} k} , n = 0 , … , N - 1.$$

Thus, the modulated OFDM vector signal with N subcarriers can be expressed as:

X_{N}=IFFT{xₙ},n=0, . . . ,N−1.

### Companding Transform

Still referring to FIG. 1, a companding transform is applied. The companding transform can be viewed as a predistortion procession applied to multiplexed signals. In particular, the proposed companding transform properly transforms the multiplexed signals according to a power distribution of the signals, so that the average power increases and the improved sensitivity to the nonlinearity of a high-power-amplifier (“HPA”) can be avoided. A μ-law companding transform is considered for most applications. This μ-law companding transform enlarges small signals and compresses large signals. A signal \hat{X}_{N}′ after a companding transform at a transmitter can be expressed as:

$${\hat{X}}_{N}^{′} = \frac{A sgn ( {\hat{X}}_{N} ) ln ( 1 + μ \vert \frac{{\hat{X}}_{N}}{A} \vert )}{ln ( 1 + μ )} ,$$

where signal \hat{X}_{N} is after an IFFT; μ is a companding coefficient; and A is the mean amplitude of the signal \hat{X}_{N}. At the receiver, the expanded signal is:

$${r}_{c}^{′} ( n ) = sgn ( {r}_{c} ( n ) ) {A}^{′} [ exp ( \vert {r}_{c} ( n ) \vert ) \frac{ln ( 1 + μ )}{{A}^{′}} - 1 ] / ln ( 1 + μ ) .$$

The μ-law companding transform may further reduce the PAPR.

In certain aspects of the present invention, one or more of the elements provided may take the form of computing devices. A “computing device”, as used herein, refers to a general purpose computing device that includes a processor. A processor generally includes a Central Processing Unit (“CPU”), such as a microprocessor. A CPU generally includes an arithmetic logic unit (“ALU”), which performs arithmetic and logical operations, and a control unit, which extracts instructions (e.g., code) from a computer readable medium, such as a memory, and decodes and executes them, calling on the ALU when necessary. “Memory”, as used herein, generally refers to one or more devices or media capable of storing data, such as in the form of chips or drives. Memory may take the form of one or more random-access memory (“RAM”), read-only memory (“ROM”), programmable read-only memory (“PROM”), erasable programmable read-only memory (“EPROM”), or electrically erasable programmable read-only memory (“EEPROM”) chips, by way of further non-limiting example only. Memory may take the form of one or more solid-state, optical or magnetic-based drives, by way of further non-limiting example only. Memory may be internal or external to an integrated unit including the processor. Memory may be internal or external to a computing device. Memory may store a computer program, e.g., code or a sequence of instructions being operable by the processor. In certain aspects of the present invention, one or more of the elements provided may take the form of code being executed using one or more computing devices, such as in the form of computer device executable programs or applications being stored in memory.

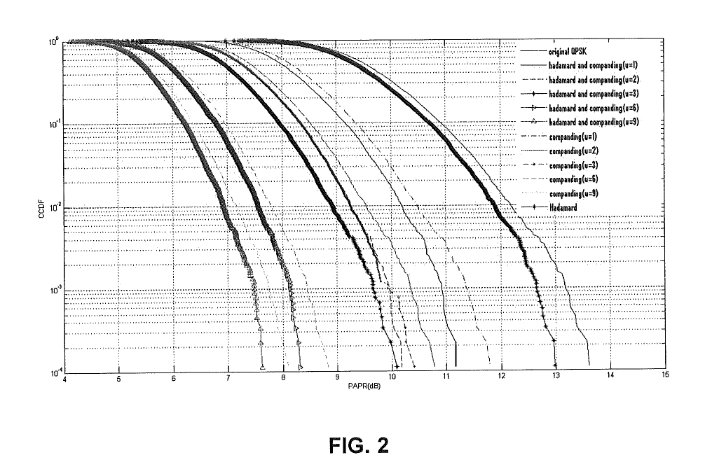

Referring to FIG. 2, CCDF curves of an original OFDM signal and an OFDM signal with a Hadamard transform are shown. It is evident that the OFDM signal using a Hadamard transform has a 0.8 dB PAPR lower than that of the original OFDM signal when the CCDF is 1×10−4, for example. The OFDM system with the proposed μ-law companding transform (with companding coefficient μ=1, 2, 3, 6, and 9) may improve the PAPR by 2 to 5.6 dB with respect to the original OFDM system when the CCDF is 1×10−4.

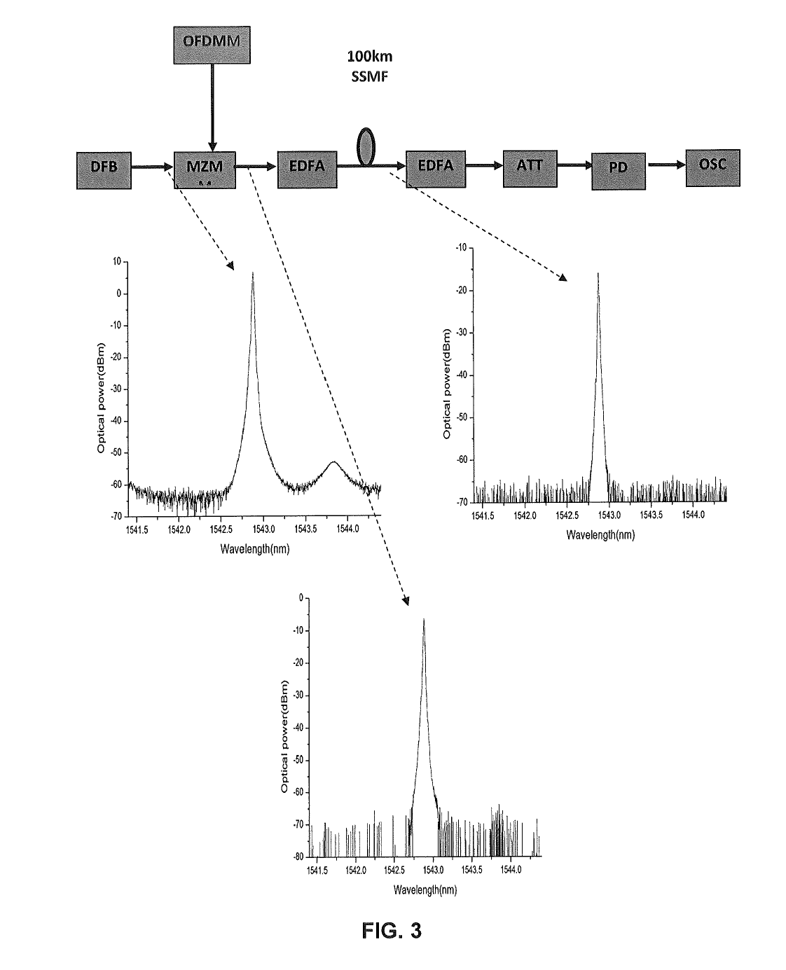

FIG. 3 shows an experimental setup for an IM-DD OFDM transmission system with a Hadamard transform combined with a companding transform technique. In this setup, there are 256 OFDM subcarriers. Among these subcarriers, 192 are used for data, 8 are used for pilots, and 56 are used for guard intervals. The cyclic prefix is ⅛ of an OFDM symbol duration, which would be 32 samples for every OFDM frame. QPSK is employed for the subcarrier modulation scheme. The OFDM signal is generated offline and uploaded into an arbitrary waveform generator (“AWG”). In a receiver, a Matlab® program is used to process a waveform recorded by a real-time oscilloscope. The bit rate of the OFDM signal is 2.5 Gbit/s. There are four types of OFDM signals in this experiment: original QPSK-OFDM signals, OFDM signals using a Hadamard transform combined with a companding transform, OFDM signals using only a companding transform, and OFDM signals using only a Hadamard transform. Different fiber launch powers are used to measure the bit error rate performance of the four types of OFDM signals.

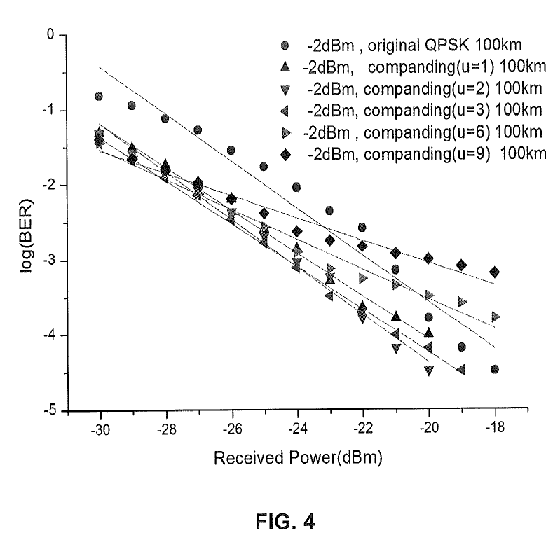

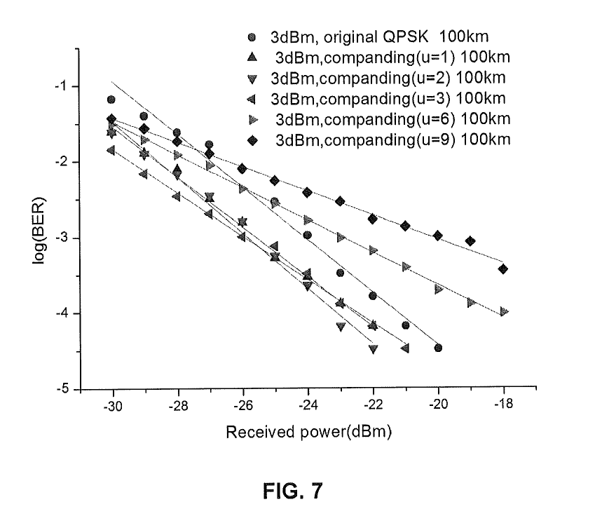

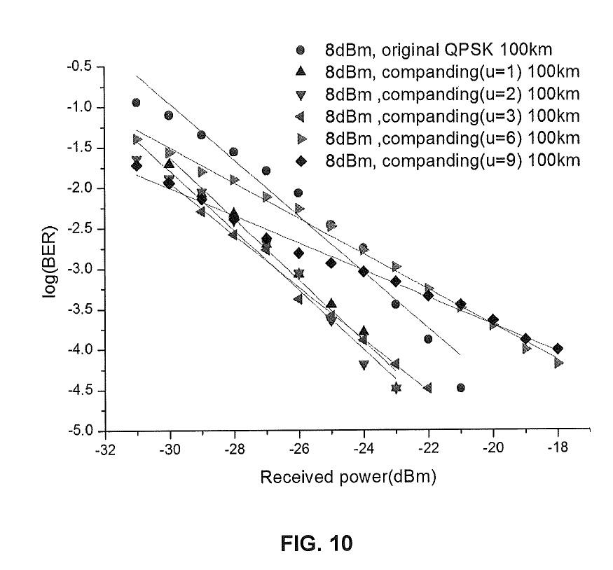

FIGS. 4, 7, and 10 compare BER performance of an OFDM signal using a companding transform with companding coefficient μ=1, 2, 3, 6, and 9 after 100 km Standard Single Mode Fiber (“SSMF”) transmission at different fiber launched powers. FIGS. 4, 7, and 10 show that the BER performance of the OFDM signal using a companding transform is optimal when the companding coefficient μ=2.

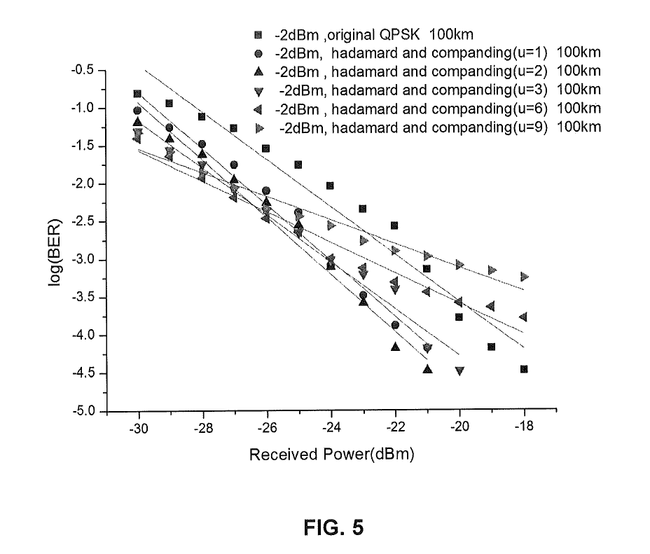

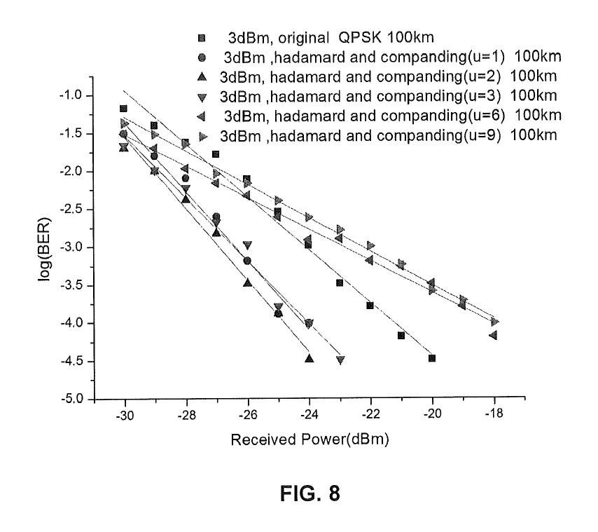

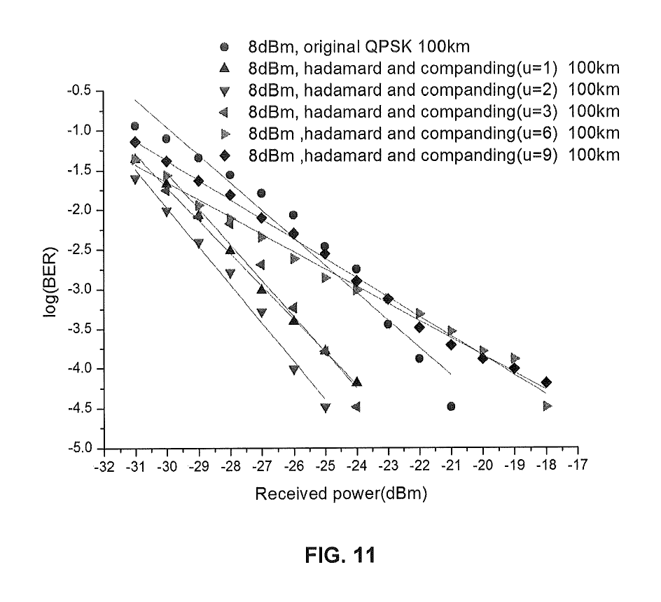

FIGS. 5, 8, and 11 compare BER performance of the OFDM signal using a Hadamard transform combined with a companding transform (with μ=1, 2, 3, 6 and 9) after 100 km SSMF transmission at different fiber launched powers. FIGS. 5, 8, and 11 also show that the BER performance of the OFDM signal using a Hadamard transform combined with a companding transform (with μ=1, 2, 3, 6 and 9) is optimal when the companding coefficient μ=2.

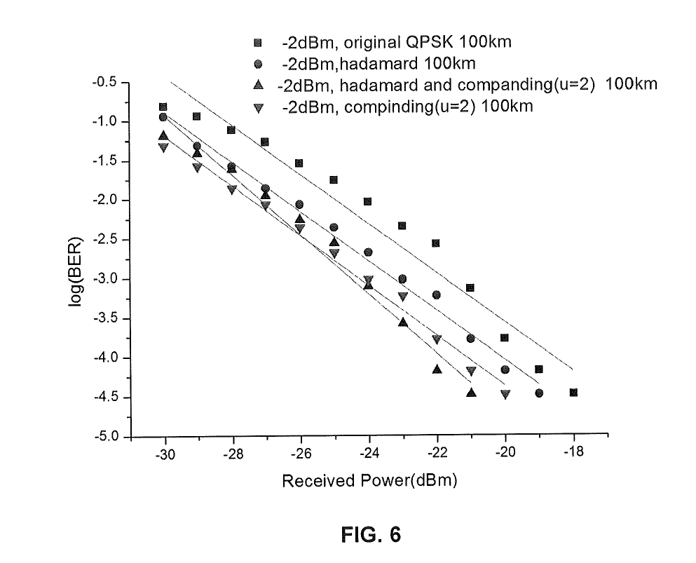

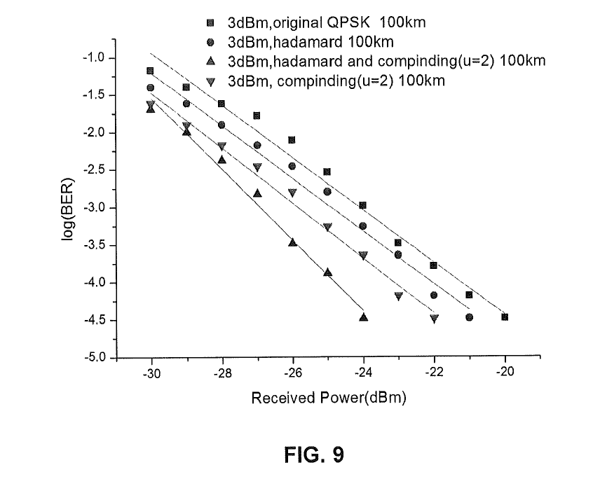

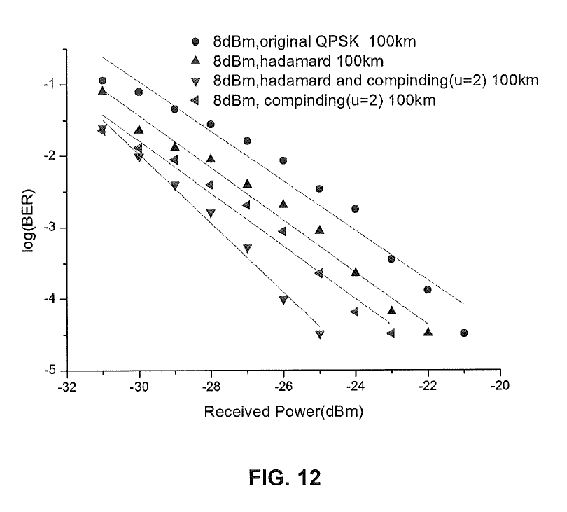

FIGS. 6, 9, and 12 compare the BER performance of the OFDM signal using a Hadamard transform combined with a companding transform with μ=2, a OFDM signal using a companding transform with μ=2, and a OFDM signal with Hadamard transform and original QPSK-OFDM signal after 100 km SSMF transmission at the same fiber launch power. These figures show that the BER performance of the OFDM signal using the Hadamard transform combined with a companding transform (μ=2) technique is optimal. Moreover, with an increase in the fiber launch power, the combining scheme can offer better BER performance.

Furthermore, the combined use of the Hadamard transform and companding transform results in a greater reduction in the PAPR of the system. Consequently, a system with the lowest PAPR will lead to the least nonlinear impairment.

Moreover, for lower fiber launched power, there is nonlinear distortion in transmission fiber, and the capacity of the system is mainly influenced by the linearity of high power amplifiers (“HPA”) and other components. However, nonlinear distortion effects of the transmission fiber become severe with fiber launch power is increased, becoming an important factor in system performance. As is shown in FIGS. 6, 9, and 12, the received sensitivity significantly increases for the fiber launched power. Therefore, reducing the PAPR of optical OFDM signals may not only minimize nonlinear distortion effects of HPA and Analog-to-Digital Converters, but also significantly reduce the effect of fiber nonlinearity.

While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. A method of decreasing a peak-to-average power ratio of orthogonal frequency division multiplexed signals, the method comprising:
applying a Hadamard transform to a signal to generate a first transformed signal;
performing an Inverse Fast Fourier Transform on the signal to generate a second transformed signal;
companding the second transformed signal to generate a companded signal; and
optically transmitting the companded signal.

2. The method of claim 1, wherein the second transformed signal is represented by:
$${x}_{n} = \frac{1}{\sqrt{N}} {\sum }_{k = 0}^{N - 1} {X}_{k} \cdot {e}^{j 2 π \frac{n}{N} k} , n = 0 , … , N - 1. ,$$
wherein N is a subcarrier number, and Xₖ is a plurality of samples of the orthogonal frequency division multiplexed signals.

3. The method of claim 2, wherein the companded signal is represented by:
$${r}_{c}^{′} ( n ) = sgn ( {r}_{c} ( n ) ) {A}^{′} [ exp ( \vert {r}_{c} ( n ) \vert ) \frac{ln ( 1 + μ )}{{A}^{′}} - 1 ] / ln ( 1 + μ ) ,$$
wherein μ is a companding coefficient, and A is a mean amplitude of the companded signal.

4. The method of claim 3, wherein 1≦μ≦9.

5. A system of decreasing a peak-to-average power ratio of orthogonal frequency division multiplexed signals, the system comprising:
means for applying a Hadamard transform to a signal to generate a first transformed signal;
means for performing an Inverse Fast Fourier Transform on the signal to generate a second transformed signal;
means for companding the second transformed signal to generate a companded signal; and
means for optically transmitting the companded signal.

6. The system of claim 5, wherein the second transformed signal is represented by:
$${x}_{n} = \frac{1}{\sqrt{N}} {\sum }_{k = 0}^{N - 1} {X}_{k} \cdot {e}^{j 2 π \frac{n}{N} k} , n = 0 , … , N - 1. ,$$
wherein N is a subcarrier number, and Xₖ is a plurality of samples of the orthogonal frequency division multiplexed signals.

7. The system of claim 6, wherein the companded signal is represented by:
$${r}_{c}^{′} ( n ) = sgn ( {r}_{c} ( n ) ) {A}^{′} [ exp ( \vert {r}_{c} ( n ) \vert ) \frac{ln ( 1 + μ )}{{A}^{′}} - 1 ] / ln ( 1 + μ ) ,$$
wherein μ is a companding coefficient and A is a mean amplitude of the companded signal.

8. A computer program product for decreasing a peak-to-average power ratio of orthogonal frequency division multiplexed signals, the computer program-product residing on a computer-readable medium and comprising computer-readable instructions configured to cause a computer to:
apply a Hadamard transform to a signal to generate a first transformed signal;
perform an Inverse Fast Fourier Transform on the signal to generate a second transformed signal;
compand the second transformed signal to generate a companded signal; and optically transmit the companded signal.

9. The product of claim 8, wherein the output signal is represented by:
$${x}_{n} = \frac{1}{\sqrt{N}} {\sum }_{k = 0}^{N - 1} {X}_{k} \cdot {e}^{j 2 π \frac{n}{N} k} , n = 0 , … , N - 1. ,$$
wherein N is a subcarrier number, and Xₖ is a plurality of samples of the orthogonal frequency division multiplexed signals.

10. The product of claim 9, wherein the companded signal is represented by:
$${r}_{c}^{′} ( n ) = sgn ( {r}_{c} ( n ) ) {A}^{′} [ exp ( \vert {r}_{c} ( n ) \vert ) \frac{ln ( 1 + μ )}{{A}^{′}} - 1 ] / ln ( 1 + μ ) ,$$
wherein μ is a companding coefficient and A is a mean amplitude of the companded signal.

11. The product of claim 8, wherein 1≦μ≦9.
